(19) United States
(12) Patent Application Publication
(10) Pub. No.: US 2017/0067234 A1
(43) Pub. Date: Mar. 9, 2017

(54) VALVE FOR PURGING A UTILITIES PIPE

(71) Applicant: Owen Edward Lindsay NOTT, Bonville, New South Wales (AU)

(72) Inventor: Owen Edward Lindsay Nott, Bonville, NSW (AU)

(21) Appl. No.: 15/308,013

(22) PCT Filed: May 20, 2015
(86) PCT No.: PCT/AU2015/050259

§ 371 Date: Oct. 31, 2016

(30) Foreign Application Priority Data
May 20, 2014 (AU) 2014202753

(51) Int. Cl. E03B 7/08; B08B 9/032; F16L 55/10; F16K 37/00; F16K 3/04; F16L 55/07

(52) U.S. Cl. CPC E03B 7/08; F16K 3/04; F16L 55/07; F16L 55/10; F16K 37/0008; B08B 9/0321

(57) ABSTRACT

A valve including two component parts, with a first part being rotationally mounted to the second part, wherein a through passage is provided in each part and the passages are in fluid communication when the parts are rotated into an open position, to allow flow 5 through the valve, wherein each part has a threaded socket and a threaded male connector, and wherein the passage extends axially, through the male connector and opens into the socket.

### FIELD OF THE INVENTION

The present invention relates to a valve for purging a utilities pipe.

### BACKGROUND OF THE INVENTION

Utilities such as water and gas are delivered to a building via mains lines and are then networked into sections of the building by pipe-work connected into the lines. In construction of an apartment building, for example, a separate water pipe is connected into the mains and installed in each room where delivery of water is needed.

The mains water is turned off when the pipe work is installed to the required areas. Once installed, the water mains is turned on and the pipe work is tested for leaks. Before use, each pipe must be purged or flushed, which is a two person operation, where a first person controls a mains valve to turn the water on, after a cap has been removed from the pipe, and the other person holds a bucket or the like to collect water flushed through the pipe and then signals to the first person to close the mains valve. The cap is then replaced.

This process of purging the pipe is time consuming and communication between the two people undertaking the operation can be difficult, especially if the mains is remote from the pipe. The process is also time consuming since the mains needs to be turned off after each pipe is flushed.

### OBJECT OF THE INVENTION

The present invention seeks to provide a valve for use in purging a pipe.

### SUMMARY OF THE INVENTION

In accordance with the invention, there is provided a valve including two component parts, with a first part being rotationally mounted to the second part, wherein a through passage is provided in each part and the passages are in fluid communication when the parts are rotated into an open position, to allow flow through the valve, wherein each part has a threaded socket and a threaded male connector, and wherein the passage extends axially, through the male connector and opens into the socket.

The valve can be used to purge a utilities pipe connected to a mains supply by coupling the valve to a fitting associated with the pipe, turning the mains supply on and opening the valve to flush the pipe.

Valves can be coupled to multiple pipes connected to the mains.

With the above, the mains supply can be left on, and used as required, during a construction phase of a building. In addition, the purging operation can be conducted by a single person, who is able to switch the mains supply on and off independently of the pipes being flushed.

Preferably, the passage is in the form of an annular slot.

Preferably, the male connector of either part is adapted to screw into a pipe fitting in the form of a breach piece, and the internal thread of the socket matches the external diameter of the male connector, such that either component parts can be used interchangeably to connect to the pipe fitting.

Preferably, the male connector has an external diameter in the order of about ⅝″.

Alternatively, the internal diameter of the socket is in the order of ½″ to fit on an a pipe fitting in the form of an external thread on the pipe.

Preferably, the external profile of one of the parts includes multiple grip surfaces around a perimeter of the part, to allow the part to be gripped and rotated from multiple directions.

Preferably, the grip surfaces are in the form of radial projections that also indicate the open or closed condition of the valve, when compared with corresponding indicators on the other part.

Preferably, the valve includes a gasket fitted to at least the first part to provide a seal between the threaded male connector of the first part and the socket of the second part.

Preferably, the gasket is mounted to an end of the male connector of the first part.

Preferably, the gasket includes an aperture that aligns with the associated passage through the end of the male connector.

Preferably, the end of the male connector of the first part includes a recess and the gasket has a locking lug that registers with the recess to locate the gasket over the end of male connector so that the aperture aligns with the associated passage.

Preferably, a gasket is fitted to the male connector of the second part of the valve.

In another aspect there is provided a component part of the above described valve, including a threaded male part at a first end, a threaded socket at an opposite end and a through passage that extends from the first end and preferably opens into a base of the socket.

Preferably, the body of the valve has an external profile with multiple grip surfaces to allow the body to be gripped from multiple directions.

Preferably, the body has a triangular shape with three lobes that form the grip surfaces.

### BRIEF DESCRIPTION OF THE DRAWINGS

The invention is described, by way of example only, with reference to the accompanying drawings, in which:

FIG. 1 is a perspective view of a valve, formed of first and second component parts;

FIG. 2a is plan view of the first component part;

FIG. 2b is a perspective view of the part;

FIG. 2c is a front view of the part;

FIG. 2d is a cross-sectional view of the part, taken along the line A-A of FIG. 1c;

FIG. 3a is a plan view of the second component part;

FIG. 3b is a perspective view of the second part;

FIG. 3c is a front view of the second part;

FIG. 3d is a perspective view of the second part;

FIG. 3e is a cross-sectional view of the second part, taken along the line B-B of FIG. 2d;

FIG. 4a is a plan view of a three component valve;

FIG. 4b is a perspective view of the valve of perspective view of a valve of FIG. 4a;

FIG. 4c is a front view of the valve of FIG. 4a;

FIG. 4d is a cross-sectional view of the valve, along the line C-C of FIG. 4c;

FIG. 5 is a diagrammatic view of the valve of FIG. 1, connected to a pipe fitting;

FIG. 6 is a diagrammatic view of the valve of FIG. 1, connected to an alternative pipe fitting.

FIG. 7 illustrates perspective views of a gasket;

FIG. 8 is a cross-sectional view of the gasket;

FIG. 9a is an exploded perspective view of another valve;

FIG. 9b is a plan view of the valve of FIG. 9a; and

FIG. 9c is a cross-sectional view of the valve of FIG. 9b.

### DETAILED DESCRIPTION OF THE INVENTION

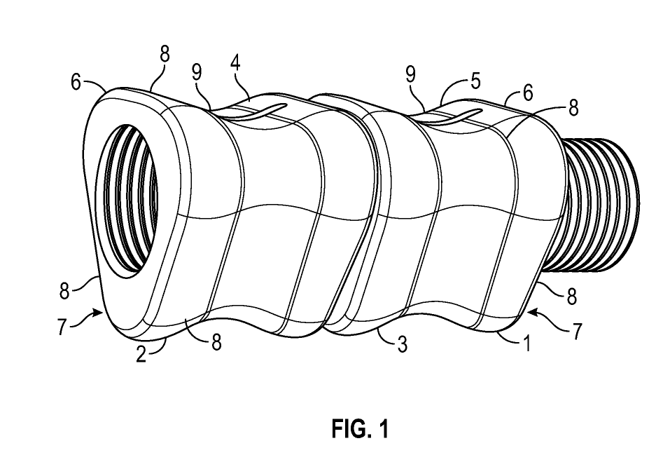

FIG. 1 shows a valve 1 formed of two component parts 2, 3 rotationally coupled together. Each part is formed of a body 4, 5 with a generally triangular shaped external profile 6. The profile 6 is comprised of series of three lobe shaped structures 7 that provide grip surfaces 8 around a periphery 9 of the parts 2, 3.

The grip surfaces 8 are arranged about the periphery 9 to allow either one of the parts 2, 3 to be gripped and rotated from multiple different directions.

The lobe structures 7 also act as position indicators to allow for easy identification of the relative orientation of the parts 2, 3 although any other form of positioning indicating structure can, of course, be used. When the lobe structures align, for example, the valve 1 is indicated as being in an open condition.

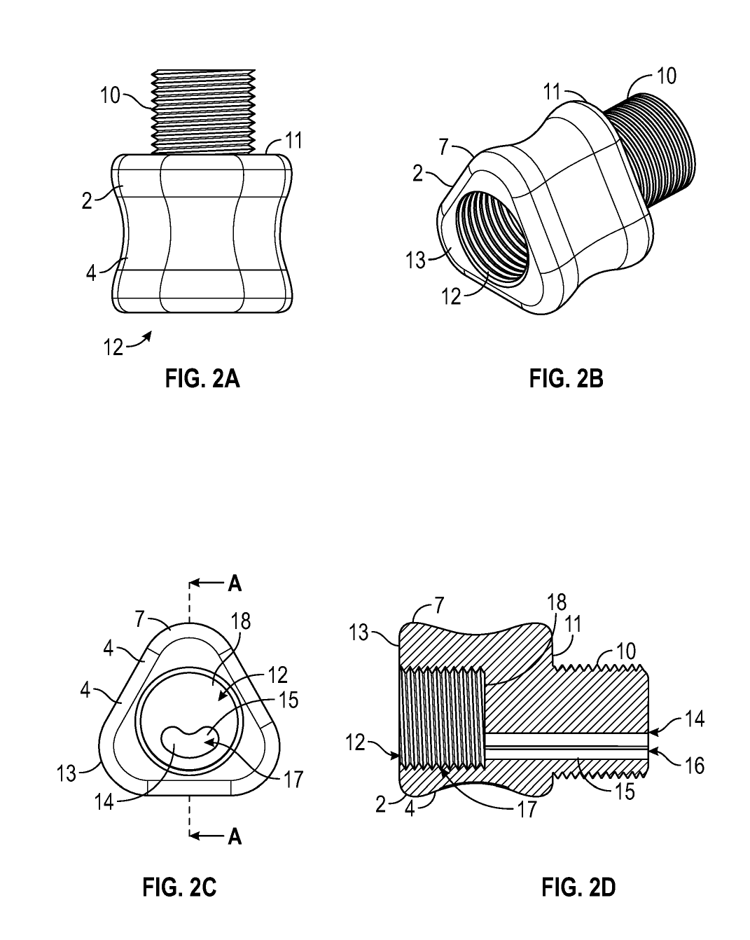

Referring now to FIG. 2, the construction of the first part 2 is more clearly shown. The part 2 has a male connector 10 that projects from a first end 11 of the body 4 and a threaded socket 12 is formed in an opposite end 13. A through passage 14, in the form of a lengthwise slot 15, extends from an opening 16 in the first end 11, axially through the body 4, to an outlet 17 formed in a base 18 of the socket 12, in order to provide fluid communication between the first end 11 and the socket 12.

The male connector 10 may have an outer diameter of about ⅝″ and the inner dimension of the socket 12 will have a matching diameter. The length of the body 4 may be in the order of about 32 mm and the length of the male connector 10 may be in the order of 20 mm.

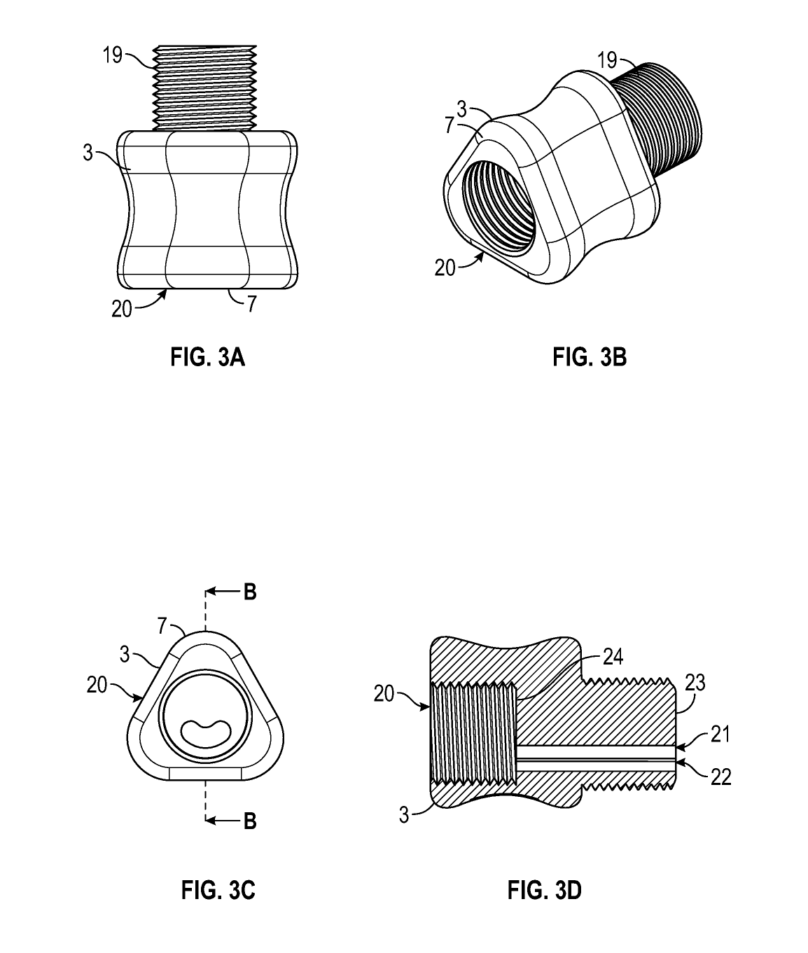

Referring now to FIG. 3, the second component part 3 is of substantially the same construction as the first component part 2 and like reference numerals are used to denote like parts.

The second component part 3 is formed in a similar manner, with the threaded male connector 19 and socket 20 and a through passage 21 that communicates from an opening 22 in an end 23 of the male connector 19, to a base 24 of the socket 20.

The dimensions of the second component part 3 may be identical to the first component part 2 except the length dimension of the male connector 19 of the second part 2 may be marginally smaller, in the order of 18 mm.

The socket 20 of the second part 3 is thereby dimensioned to receive the male connector 10 of the first part 2 and when the first part 2 is fully screwed into the socket 20 of the second part 3, the opening 16 of the passage 14 is sealed against the base 24 of the second part 3. In that position, the lobe structures 7 of the first and second parts 2, 3 will be out of alignment, to indicate a closed condition, where fluid flow through the parts 2, 3 is prevented.

When the first part 2 is rotated relative to the second part 3, to align the lobe structures 7, fluid communication between the passages 14 and 21 is again established. The male connector 10, 19, and the inner diameter of the associated socket 12, 20, for both the first and second parts 2, 3 can have a different diameter such as in the order of ½″ for screw threaded attachment in an alternative application.

The above dimensions are given by way of example only and other dimensions may instead be used, as required.

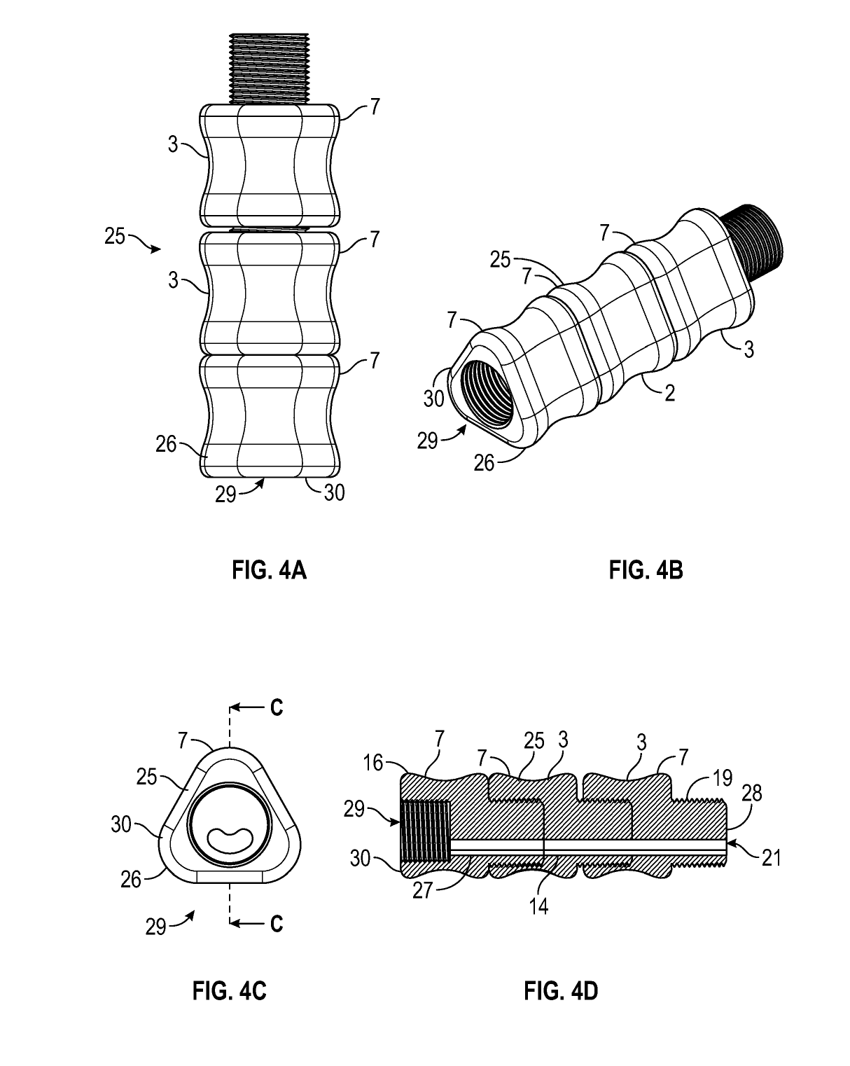

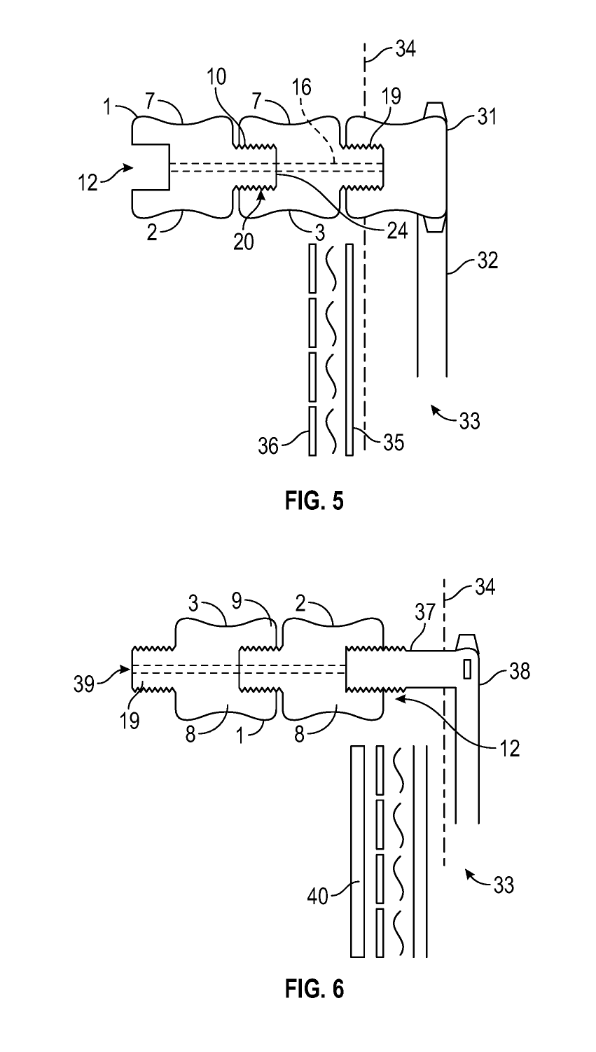

Turning now to FIG. 4, another valve 25 is shown as including three component parts 2, 3, 26. It may be appreciated all the component parts 2, 3, 26 may be produced in a modular form so that multiple parts can be added to the valve 25, as required, in order to extend the overall length of the valve 25. The valve is shown in an open condition, where all of the lobe structures 7 of each of the component parts 2, 3 26 are aligned, which places the respective passage 14, 21, 27 in each part 2, 3, 26 in fluid communication, so that fluid can pass from male connector 19 at one end 28 of the valve, through to the socket 29 of the other end 30. The valve 25 can be moved to a closed condition through relative rotation of one of the parts 2, 3, 26 out of alignment, to shut off fluid communication between the parts 2, 3, 26.

Referring to FIG. 5, the valve 1 is shown fitted to a standard ⅝″ breach fitting 31, during a construction phase of a building. The breach fitting 31 provides for connection to a water pipe 32 that is in turn connected to a water mains. The breach fitting 31 is recessed in a wall cavity 33, behind a wall 34 that includes cladding 35 and tiling 36.

With the mains turned off, the male connector 19 of the valve part 3 is screwed into the fitting 31 and the male connector 10 of the other part 2 is then screw threaded into the socket 20, until the valve 1 is in closed condition, so that the opening 16 of the passage 14 is sealed against a base 24 of the socket 20.

Multiple valves 1 can be coupled to an associated multiple number of water pipes and respective fittings 31, to effectively close off all the pipes. The water mains can then be turned on.

In order to purge the pipe shown in FIG. 5, the first part 2 of the valve 1 is simply rotated relative to the second part 3, in order to establish flow through the valve 1. When the opened, the lobe structures 7 on the parts 2, 3 are in alignment, to indicate the open condition of the valve 1.

Prior to purging the pipe 32, a secondary hose (not shown) may be screw fitted into the socket 12 so that any water that is flushed through the pipe 32 is able to be conveniently contained or redirected, to a bucket or the like.

Once the pipe 32 is purged, the valve 1 is returned to the closed condition by rotating the first part 2 back to the original position relative to the second part 3. As may be appreciated, the purging operation can be completed quickly and cleanly using only a single person. Since the mains water is left on during the purging operation, water can still be made available to a building site so that other construction activities can continue without disruption of water supply.

FIG. 6 shows another application of the valve 1. In this case, the socket 12 of the first part 2 is used to connect the valve 1 to a fitting 37 in the form of a ½″ thread on a water pipe 38 and the outlet 39 of the valve is the male connector 19 of the second part 3. The valve 1 is operated in the same manner as the valve of FIG. 6.

With valve 1 shown in either FIG. 5 or 6, the component parts 2, 3 project from the fitting 31, 37 to a convenient location outside the wall cavity 33. In FIG. 6, cabinetry 40 or the like may be constructed over the wall 34 and access to the valve 1 may be restricted. For example, the cabinetry 40 may be positioned particularly close to one side of the valve 1. However, the valve can still be reliably operated as the grip surfaces 8 are provided around the periphery 9 of the valve 1 and allow the valve 1 to the operated from multiple directions/sides.

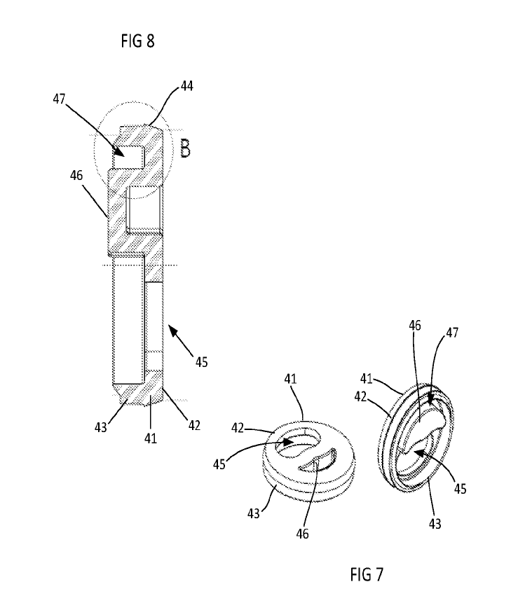

Referring now to FIGS. 7 and 8, a gasket 41 is shown as having a circular head 42 and an annular skirt 43. The head includes a tapered side edge 44 a bean-shaped aperture 45. A crescent shaped locking lug 46 is integrally moulded with the head 24. The lug 46 projects past the skirt 43 and defines a radial gap 47 between lug 46 and the skirt 43.

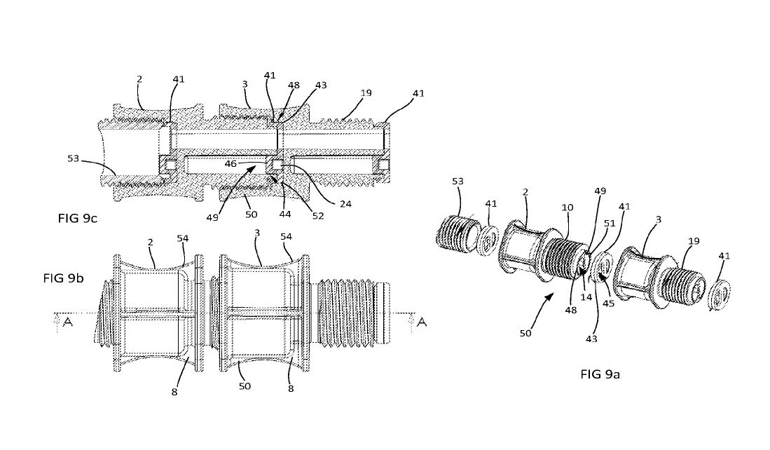

The gasket 41 fits onto the male connector 10 of the first component part 2 of the valve 50 shown in FIG. 9. Although the valve 50 is of a different construction to the valve 1 described with reference to FIGS. 1 to 3, the valve 50 has the same functionality and like reference numerals will be used to describe like parts.

As shown in FIG. 9a, the gasket 41 is positioned so that the skirt 43 is located over a rebated shoulder 48 of the male connector 10 so that the lug 46 registers with a corresponding recess 49 in the end 51 of the male connector 10 and the aperture 45 aligns with the passage 14.

With regard to FIG. 9c, the gasket 41 is shown fitted to the male connector 10 by virtue of the lug 46 being inserted into the recess 49 and the skirt 43 being an interference fit over the shoulder 48. In that position, the gasket 41 is arranged whereby the tapered side edge 44 also has an interference fit with a well 52 formed in a base 24 of the second component part 3 so as to form a seal between the first and second component parts 2, 3 when the component parts are rotated between open and closed positions.

A second gasket 41 may also be fitted to the male connector 19 of the second component part 3, if required and/or to an additional threaded fitting 53 that may be connected to a hose or the like.

In FIG. 9, the lobe shaped structure 7 of the valve 1 have been replaced with elongate ribs 54, however, the ribs 54 provide the same functionality as grip surfaces 8 and position indications to identify the open or closed state of the valve 50.

The invention has been described by way of example only, with reference to water pipes. However, the valve can equally be applied to other utilities such as gas, to allow the gas mains to be left on while individual gas pipes are purged. The invention can provide considerable time and cost savings compared to convention gas pipe purging techniques where the mains otherwise need to be switched on and off and pipes separately taped and capped before and after each purge operation.

Another advantage of the invention is that each of the valve parts can be made as a single interchangeable unit so that only one unit needs to be produced, which can be then be used interchangeably as the first or second part 2, 3, providing manufacturing efficiencies and savings.

### LIST OF PARTS

1. Valve

2. Component part

3. Component part

4. Body

5. Body

6. Profile

7. Lobe shaped structure

8. Grip surface

9. Periphery

10. Male connector

11. First end

12. Socket

13. Opposite end

14. Passage

15. Slot

16. Opening

17. Outlet

18. Base

19. Male connector

20. Socket

21. Passage

22. Opening

23. End

24. Base

25. Valve

26. Component part

27. Passage

28. End

29. Socket

30. End

31. Fitting

32. Pipe

33. Wall cavity

34. Wall

35. Cladding

36. Tiling

37. Fitting

38. Pipe

39. Outlet

40. Cabinetry

41. Gasket

42. Head

43. Skirt

44. Edge

45. Aperture

46. Lug

47. Gap

48. Shoulder

49. Recess

50. Valve

51. End

52. Well

53. Fitting

54. Ribs

1. A valve including two component parts, with a first part being rotationally mounted to the second part, wherein a through passage is provided in each part and the passages are in fluid communication when the parts are rotated into an open position, to allow flow through the valve, wherein each part has a threaded socket and a threaded male connector, and wherein the passage extends axially, through the male connector and opens into the socket.

2. The valve of claim 1, wherein the passage is in the form of slot extending axially of the associated part.

3. The valve of claim 2, wherein the male connector of either part is adapted to screw into a pipe fitting in the form of a breach piece, and the internal thread of the socket matches the external diameter of the male connector, such that either component parts can be used interchangeably to connect to the pipe fitting.

4. The valve of claim 3, wherein the male connector has an external diameter in the order of about ⅝″.

5. The valve of claim 3, wherein the internal diameter of the socket is in the order of ½″ to fit on an a pipe fitting in the form of an external thread on the pipe.

6. The valve of claim 1, wherein the external profile of one of the parts includes multiple grip surfaces around a perimeter of the part, to allow the part to be gripped and rotated from multiple directions.

7. The valve of claim 6, wherein the grip surfaces are in the form of radial projections that also indicate the open or closed condition of the valve, when compared with corresponding indicators on the other part.

8. The valve of claim 1, wherein the valve includes a gasket fitted to at least the first part to provide a seal between the threaded male connector of the first part and the socket of the second part.

9. The valve of claim 8, wherein the gasket is mounted to an end of the male connector of the first part.

10. The valve of claim 8, wherein the gasket includes an aperture that aligns with the associated passage through the end of the male connector.

11. The valve of claim 8, wherein the end of the male connector of the first part includes a recess and the gasket has a locking lug that registers with the recess to locate the gasket over the end of male connector so that the aperture aligns with the associated passage.

12. The valve of claim 8, wherein a gasket is fitted to the male connector of the second part of the valve.

13. A component part of the valve of claim 1, including a threaded male connector at a first end, a threaded socket at an opposite end and a through passage that extends from the first end and opens into the socket.

14. The part of claim 13, wherein a body of the valve has an external profile with multiple grip surfaces to allow the body to be gripped from multiple directions.

15. The part of claim 14, wherein the body has a triangular shape with three lobes that form the grip surfaces.

16. The part of claim 13, further including a gasket fitted to the male connector.

17. The part of claim 16, wherein the gasket includes a locking lug that is received in a recess in an end of the male connector so as to align an aperture in the gasket with passage.
